(19) United States
(12) Patent Application Publication
(10) Pub. No.: US 2008/0048440 A1
(43) Pub. Date: Feb. 28, 2008

(54) DIRECT PORT CONNECTION FOR TUBES

(76) Inventors: Herbert G. Anderson, Hilliard, OH (US); Jeffry Beier, Dublin, OH (US); Hiralal V. Patel, Dublin, OH (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/467,348

(22) Filed: Aug. 25, 2006

(51) Int. Cl. F16L 15/00; F16L 5/00; F16L 41/00

(52) U.S. Cl. 285/143.1; 285/137.11; 285/219; 285/220

(57) ABSTRACT

A direct port connection for connecting a tube to a port without the use of an adapter fitting. A modified port design permits the use of prior art adapter fittings as well as the direct port connection of the present invention. Consequently, the invention permits the most efficient tube-to-port connection to be determined on an application-by-application basis at the time of making the connection.

### FIELD OF THE INVENTION

The present invention relates generally to fittings for coupling a tube to another member. More particularly, the invention relates to fittings for hydraulic systems for connecting the end of a tube to a port.

### BACKGROUND OF THE INVENTION

FIG. 1 illustrates a known adapter fitting 10 for connecting a tube to a standard SAE port 15. The adapter fitting 10 includes an adapter fitting body 20 having a port end 25 configured to be screwed into and sealed to the port 15, a tube end 30 configured to receive an end of a tube 32, and a passageway 35 between the ends of the fitting permits flow of fluid through the fitting. More particularly, the port end 25 of the fitting 10 has a threaded portion that mates with a threaded portion of the port such that the adapter body 20 can be screwed into the port 15. An O-ring 40 is used to form a seal between the adapter body 20 and an angled seat surface 45 at the opening to the port 15. The tube end 30 of the fitting 10 is provided with a male thread portion (threads are not shown) for mating with a tube nut 47. The tube 32 is butted against the end face of the tube end 30 of the adapter fitting 10 and a sleeve 49, an O-ring 50, and the tube nut 47 are used to secure and seal the tube 30 to the adapter fitting 10.

Adapter fittings of the type just described are available for a wide variety of standard port designs and tube sizes. Further, such fittings are available in various shapes to suit a wide variety of applications. For example, as shown, 90 degree elbow fittings are available. The adapter fittings can also be connected to swivel mechanisms or other flexible members thereby providing even more versatility.

Such prior art adapter fittings, however, typically have at least two potential leak points (e.g., the port-fitting seal and the fitting-tube seal) and require tightening of at least two threaded components to form the sealed connection. Further, in applications where space is a concern or a shaped or flexible fitting is not needed, the use of an adapter fitting can be problematic or represent an unnecessary cost.

### SUMMARY OF THE INVENTION

The present invention provides a direct port connection for connecting a tube to a port in a body without the use of an adapter fitting. A preferred modified port design enables the use of prior art adapter fittings as well as the direct port connection of the present invention. Consequently, the invention allows the most efficient tube-to-port connection to be determined on an application-by-application basis at the time of making the connection.

Accordingly, the present invention provides a port fitting assembly comprising a port body and an annular male nut through which a tube can extend. The port body has a bore opening to an outer surface of the body at an opening, an angled seat (e.g. a taper) surrounding the opening to the bore, a radially inwardly extending shoulder portion, and a female thread portion between the angled seat portion and the shoulder portion. The annular male nut is configured to trap a radially outwardly projecting flange on the end of a tube between an inner end of the male nut and the shoulder portion of the bore. The male nut includes a male thread portion for engaging the female thread portion of the bore such that the male nut can be tightened to hold the flange on the tube to the shoulder of the bore.

An annular flange sealing member can be interposed between the shoulder of the bore and the flange on the tube to effect an annular seal therebetween. The flange sealing member may have an annular carrier body and an annular seal protruding axially from one and preferably both axial sides of the carrier body respectively for engaging the flange on the tube and the shoulder of the bore. The flange sealing member may also have at least one resilient retaining tab protruding radially outwardly from the relatively rigid annular body for engaging the inner diameter of the bore whereby the sealing member can be retained in the bore upon insertion into the bore.

Preferably, the shoulder of the bore resides in a plane perpendicular to a center axis of the bore, and an annular nut sealing member is provided for sealing between the male nut and the angled seat.

The port fitting assembly has particular application with a flange that is provided on the tube by means of a flange on a sleeve that is attached to an end of the tube. The sleeve preferably is joined to the tube by a fluid-tight connection, such as by welding or brazing. The sleeve may have a tubular portion, and the nut may have a counterbore therein for receiving the tubular portion of the sleeve. In another embodiment, the tube may have an end deformed to form the flange. In still another embodiment, a flange collar can be interposed between the tube and the nut for reducing torque transmission from the nut to the tube during tightening of the nut.

According to another aspect of the invention, a method of connecting a tube to a port comprises the steps of (a) inserting a tube into a bore until a radially outwardly extending flange portion on the tube contacts a radially inwardly extending shoulder portion of the bore, and (b) tightening in the bore an annular male nut through which the tube extends, the male nut being configured to press the flange against the shoulder portion to form a seal. Preferably, an annular sealing member is inserted into the bore prior to inserting the tube into the bore.

According to a further aspect of the invention, there is provided a port configuration for alternatively receiving a direct tube connect fitting assembly or a standard fitting adapter. The port comprises a bore that opens to an outer surface of a port body at an opening, an angled seat surrounding the opening of the bore, which angled seat provides a sealing surface for an annular adapter seal when an adapter is received in the bore, a radially inwardly extending shoulder to which the end of a flange on a tube can be sealed, the shoulder residing in a plane perpendicular to a central axis of the bore, and a female thread portion between the angled seat portion and the shoulder portion. In a preferred embodiment, the angled seat conforms to an SAE port fitting standard. Consequently, the type of tube fitting connection to be used need not be made at the time the port is formed in a port body.

The foregoing and other features of the invention are hereinafter more fully described and particularly pointed out in the claims, the following description setting forth in detail certain illustrative embodiments of the invention, these being indicative, however, of but a few of the various ways in which the principles of the invention may be employed.

### BRIEF DESCRIPTION OF THE DRAWINGS

FIG. 1 is a partially exploded cross-sectional view of a prior art adapter fitting shown installed in a port.

FIG. 2 is a cross-sectional view of an exemplary direct port connection in accordance with the present invention.

FIG. 3 is a top view of a sealing member used in the direct port connection.

FIG. 4 is a cross-sectional view of the sealing member of FIG. 3.

FIG. 5 is a cross-sectional view of a direct port connection according to the invention, wherein a flange on the tube is formed by a double-bumped end portion of the tube.

FIG. 6 is a cross-sectional view of the direct port connection of FIG. 2, modified to include a flange collar.

FIG. 7 is a cross-sectional view of a direct port connection, modified to include a sleeve attached to the tube end.

### DETAILED DESCRIPTION

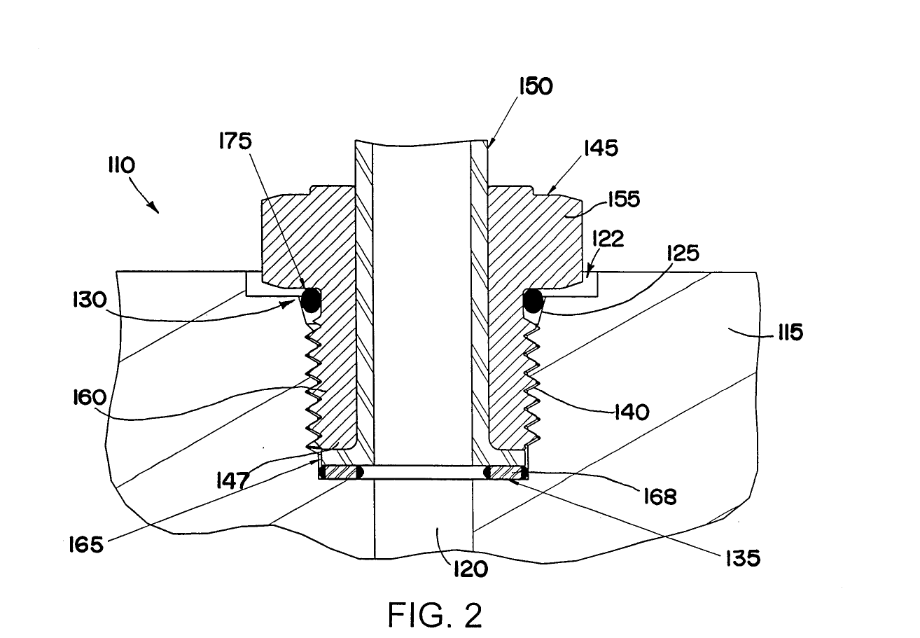

Referring now to the drawings in detail, in FIG. 2 a direct port connection is illustrated and generally indicated by reference numeral 110. The direct port connection is an assembly that includes a port body 115 having a bore 120 forming a port. The port body may have additional ports and flow passages aside from the port 120. The bore 120 includes a counterbore portion 122 and an angled seat 125 surrounding a bore opening 130. The bore 120 further includes a radially inwardly extending shoulder portion 135 formed by the intersection of a larger diameter, axially outer bore portion with a smaller diameter internal flow passage in the port body 115. The bore 120 also has a female thread portion 140 located axially between the angled seat portion 125 and the shoulder portion 135. The female thread portion 140 is provided for threaded engagement with a male thread portion 160 of a male nut 145.

The male nut 145 has an axially extending through bore through which a tube 150 extends. The bore in the male nut 145 preferably is sized so that it can be freely rotated about the tube 150 generally without resistance that otherwise might make tightening of the male nut 145 more difficult or impart an unwanted torque on the tube 150. Accordingly, the inside diameter of the male nut 145 may be slightly larger than the outside diameter of the tube 150.

The male nut 145 includes a head portion 155 and the external thread portion 160 that can be threaded into the bore 120. The head portion 155 preferably is provided with wrenching surfaces to facilitate rotation and tightening of the male nut 145 in the bore 120.

The male nut 145 has an inner end surface 147 for engaging a radially outwardly extending flange 165 on the tube 150. As will be described herein, the flange 165 can be formed integrally with the tube 150, or can be part of a separate member attached to the tube 150. In FIG. 2, the flange 165 is formed by outwardly deforming the end of the tube 150 to form a radially extending flange 165 that preferably is perpendicular to the center axis of the tube 150. While the illustrated flange 165 extends generally perpendicular (radially outwardly) from the length of the tube 150, the flange 165 could extend from the tube 150 at other angles.

The flange 165 abuts an annular sealing member 168 that is interposed between the flange 165 and the shoulder 135 of the bore 120. Accordingly, when the male nut 145 is tightened, the sealing member 168 is compressed between the flange 165 and the shoulder 135 thereby sealing the tube 150 and bore 120. For this purpose, the shoulder 135 preferably resides in a plane perpendicular to the center axis of the bore 120. That is, the shoulder surface that is engaged by the sealing member 168 is perpendicular to the bore's center axis. The annular sealing member 168 may be a separate piece that is inserted into the bore 120 prior to insertion of the tube 150 and male nut 145, or it may be joined to the flange 165 or a surface of the shoulder 135.

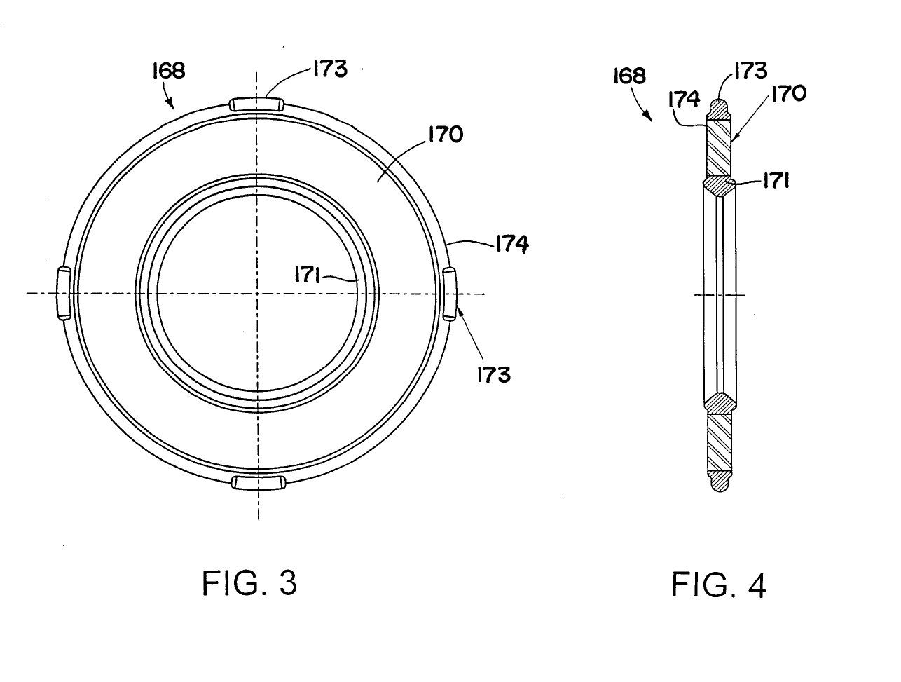

Any suitable sealing member 168 may be employed, such as that illustrated in detail in FIGS. 3 and 4, which heretofore has been used in other types of tube connections. The sealing member 168 generally includes an annular carrier body 170 and seal 171 bonded to an inner edge thereof. The illustrated seal 171 protrudes axially from both axial sides of the carrier body 170, and can be an elastomeric material, such as rubber. Resilient radially outwardly extending retaining tabs 173 are provided around an outer edge 174 of the body 170. After insertion of the sealing member 168 into a bore, such as bore 120, the resilient tabs 173 function to retain the sealing member 168 therein. Accordingly, and as desired, the sealing member 168 can be inserted into the bore 120 in advance of assembly of the direct port connection 110. It will be appreciated that the present invention is not limited to the use of the sealing member 168 and that other types of sealing members can be used in accordance with the present invention.

Returning to FIG. 2, another sealing member, such as an O-ring 175, can optionally be provided to seal a surface of the male nut 145 to the angled seat portion 125 of the bore 120. The O-ring 175 generally functions to prevent dirt and/or moisture from entering the bore 120, and may provide a secondary sealing function to prevent leakage from the bore 120.

To assemble the direct port connection 110, the sealing member 168 is inserted into the bore 120. As described, tabs 173 can be provided on the sealing member 168 for retaining the sealing member 168 in the bore 120 prior to assembly of the direct port connection 110. Accordingly, the sealing member 168 can be inserted into the bore 120 well in advance of final assembly of the direct port connection 110. After inserting the sealing member 168 into the bore 120, the male nut 145, with the tube 150 inserted therethrough, is screwed into the bore 120 until the flange 165 contacts the seal member 168. The male nut 145 is tightened to press the flange 165 and the sealing member 168 against the shoulder portion 135, thereby to effect a seal between the end of the tube and the port body 115.

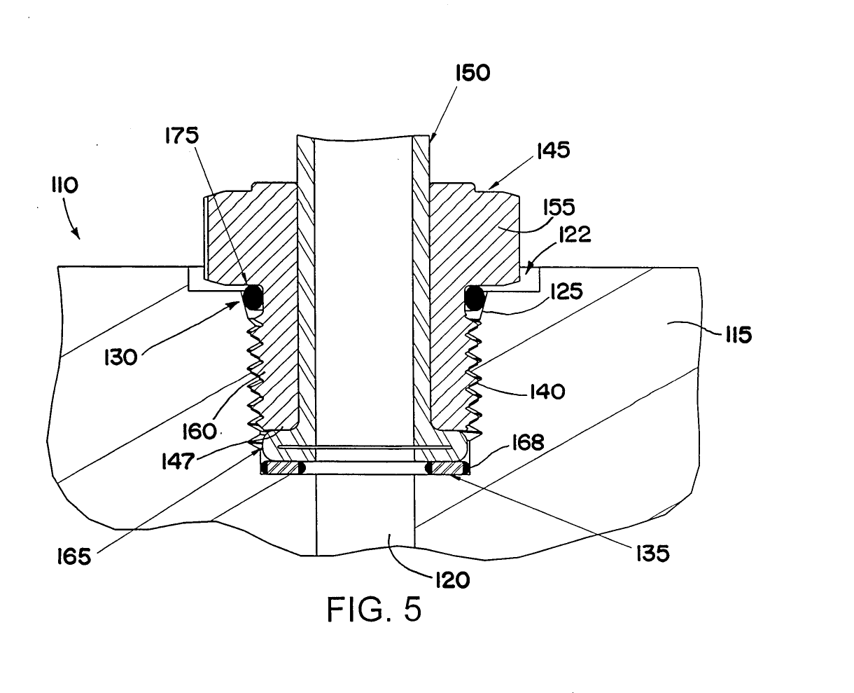

Turning to the remaining figures, in FIG. 5 another direct port connection 110 is shown. The direct port connection 110 is identical to the direct port connection of FIG. 2 (corresponding components have been given the same reference numerals in FIGS. 2 and 5-7) except that the flange 165 in FIG. 5 is formed by a double bumping process wherein the end of the tube 150 is rolled outwardly and then turned inwardly to form the flange 165 as shown.

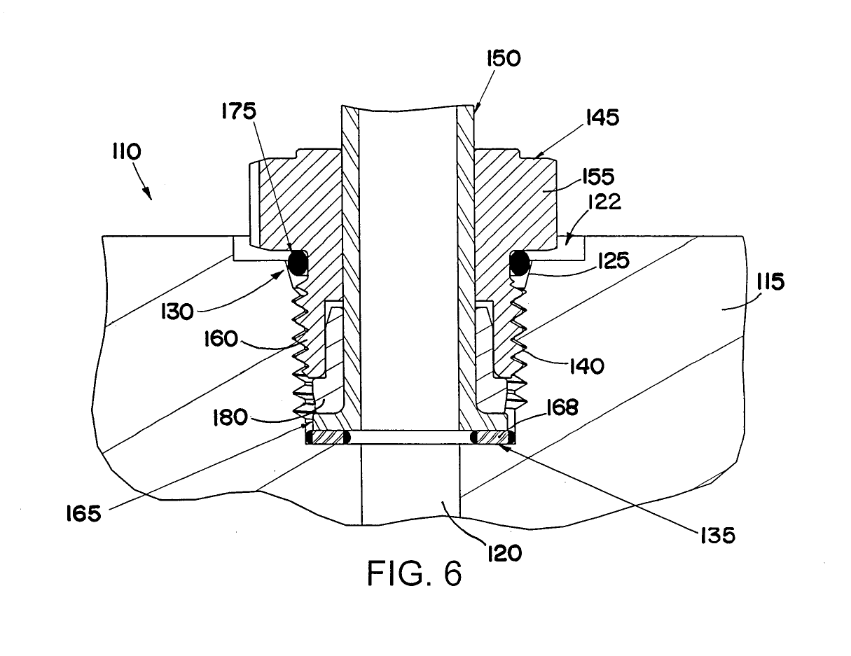

FIG. 6 is another direct port connection 110, identical to the direct port connection of FIG. 2, except that a flange collar 180 is interposed between the tube 150 and the male nut 145. The flange collar 180 is generally annular and engages the flange 165 on the tube 150. The male nut 145 includes a counterbore for receiving the flange collar 180. The flange collar 180 provides a surface against which the male nut 145 can slide when being tightened to thereby mitigate torque transfer from the male nut 145 to the tube 150 during tightening. Accordingly, the flange collar 180 can prevent twisting of the tube 150 during assembly and/or disassembly of the direct port connection 110.

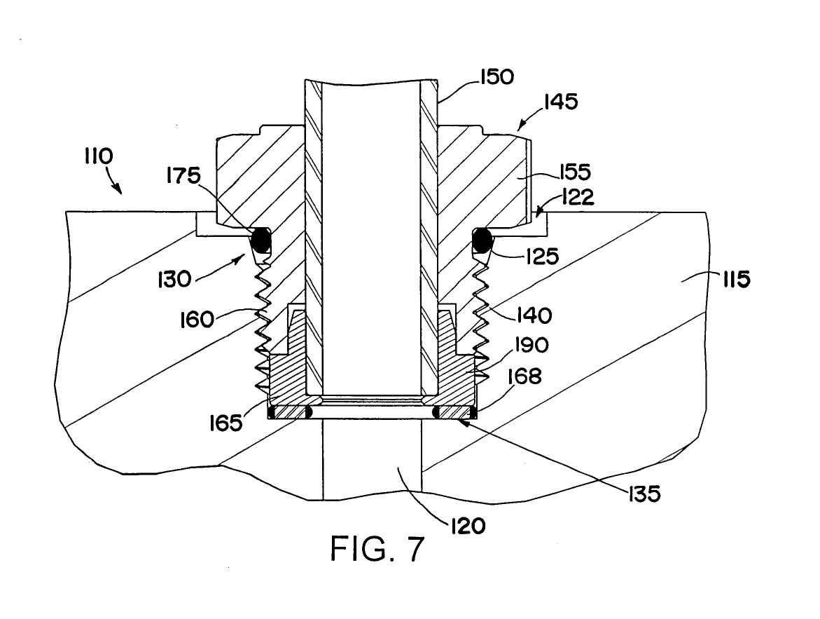

Turning to FIG. 7, yet another direct port connection is illustrated. The direct port connection 110 is identical to that described and shown in FIG. 2, except that the flange 165 is formed by a flange sleeve 190 that is connected to the tube 150. The sleeve 190 preferably is joined to the tube 150 by a fluid-tight connection, such as by welding or brazing. The sleeve 190 has a tubular portion, and the male nut 145 has a counterbore therein for receiving the tubular portion of the sleeve 190.

It will now be appreciated that the direct port connection 110 of the present invention provides a connection that, compared to traditional adapter fittings, is more economic and compact, reduces potential leak points, and requires fewer parts to be assembled.

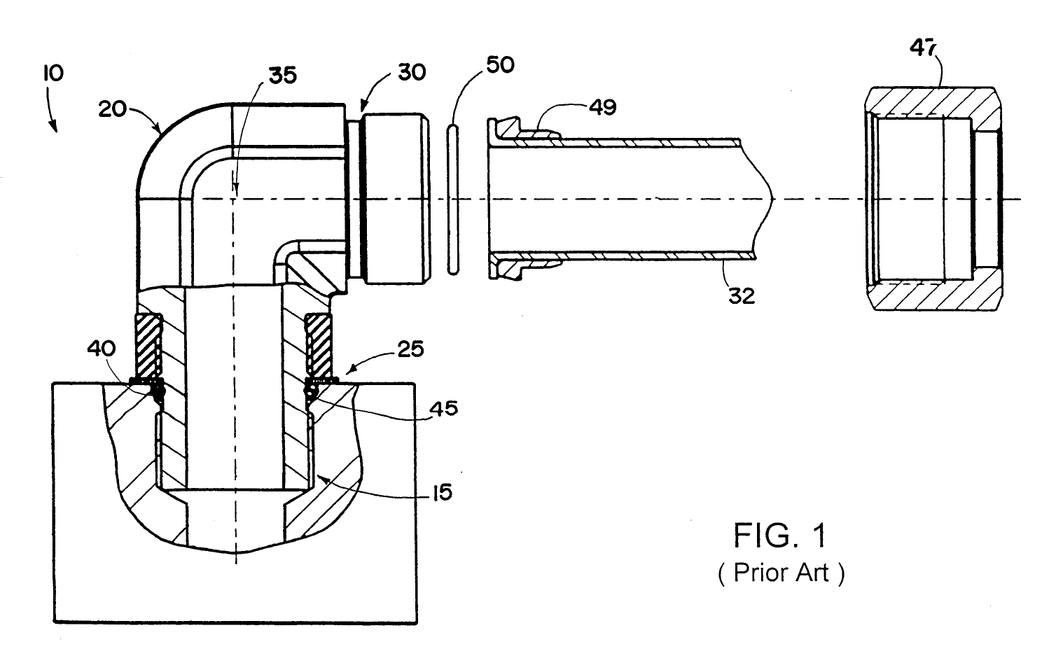

Further, it also will be appreciated that the shape of the bore 120, including the angled seat portion 125 and shoulder portion 135, permits the use of a direct port connection as set forth, as well as a conventional adapter fitting 10 as shown and described in connection with FIG. 1. The ability of the bore 120 to accept both types of connections allows the end-user to select the appropriate connection for a given application. Thus, if an adapter fitting is desired or necessary, the end-user may install an adapter fitting without the need to modify the bore 120. Alternatively, if a direct connection is desired or necessary, the end-user can install the direct port connection 110 of the present invention.

It will now be appreciated that a port can be configured in the manner set forth to accommodate a direct port connection as described, as well as traditional adaptor style connectors. Consequently, the present invention provides for the use of fittings already in use in the field, as well as the direct port connection as described. Standard ports are those for which specifications have been adopted by industry-recognized agencies such as SAE, ISO, BS and JIS.

The various embodiments of the invention have been described in relation to a tube. Unless otherwise indicated, the term “tube” or “tubes” is intended to encompass not only a tube or tubes, but also tubing, tubular fittings provided on the ends of hoses, and like tubular members, including those of generally uniform diameter extending from an end flange on the tubular member.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A port fitting assembly comprising:
a port body having a bore opening to an outer surface of the body at an opening, an angled seat surrounding the opening to the bore, a radially inwardly extending shoulder portion, and a female thread portion between the angled seat portion and the shoulder portion; and
an annular male nut through which a tube can extend, the male nut being configured to trap a radially outwardly projecting flange on the end of a tube between an inner end of the male nut and the shoulder portion of the bore, and the male nut including a male thread portion for engaging the female thread portion of the bore such that the male nut can be tightened to hold the flange on the tube to the shoulder of the bore.

2. A fitting assembly as set forth in claim 1, further comprising an annular flange sealing member that can be interposed between the shoulder of the bore and the flange on the tube to effect an annular seal therebetween.

3. A fitting assembly as set forth in claim 2, wherein the flange sealing member has an annular body and at least one resilient retaining tab protruding radially outwardly from the annular body for engaging the inner diameter of the bore whereby the sealing member can be retained in the bore upon insertion into the bore.

4. A fitting assembly as set forth in claim 2, wherein the flange sealing member has an annular carrier body and an annular seal protruding axially from both axial sides of the carrier body respectively for engaging the flange on the tube and the shoulder of the bore.

5. A fitting assembly as set forth in claim 1, wherein the shoulder resides in a plane perpendicular to a center axis of the bore.

6. A fitting assembly as set forth in claim 1, further comprising an annular nut sealing member for sealing between the male nut and the angled seat.

7. A fitting assembly as set forth in claim 1, further comprising a flange collar interposed between the tube and the nut for reducing torque transmission from the nut to the tube.

8. A fitting assembly as set forth in claim 1, in combination with the tube, and wherein the flange on the tube is formed by a flange on a sleeve that is attached to an end of the tube.

9. A combination as set forth in claim 8, wherein the sleeve is joined to the tube by a fluid-tight connection.

10. A combination as set forth in claim 9, wherein the fluid-tight connection is a welded connection.

11. A combination as set forth in claim 8, wherein the sleeve has a tubular portion, and the nut has a counterbore therein for receiving the tubular portion of the sleeve.

12. A combination as set forth in claim 8, wherein the tube has an end deformed to form the flange.

13. A method of connecting a tube to a port comprising:
inserting a tube into a bore until a radially outwardly extending flange portion on the tube contacts a radially inwardly extending shoulder portion of the bore; and
tightening in the bore an annular male nut through which the tube extends, the male nut being configured to press the flange against the shoulder portion to form a seal.

14. A method as set forth in claim 13, further comprising the step of inserting an annular sealing member into the bore prior to inserting the tube into the bore.

15. A port for alternatively receiving a direct tube connect fitting assembly or a standard fitting adapter, comprising:
a bore that opens to an outer surface of a port body at an opening;
an angled seat surrounding the opening of the bore, the annular seat providing a sealing surface for an annular adapter seal when an adapter is received in the bore;
a radially inwardly extending shoulder to which the end of a flange on a tube can be sealed, the shoulder residing in a plane perpendicular to a central axis of the bore; and
a female thread portion between the angled seat portion and the shoulder portion.

16. A port as set forth in claim 15, wherein the angled seat conforms to an SAE port fitting standard.
